(19) United States
(12) Patent Application Publication
(10) Pub. No.: US 2007/0230797 A1
(43) Pub. Date: Oct. 4, 2007

(54) Method, apparatus, and program for detecting sightlines

(75) Inventor: Ryuji Hisanaga, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/730,126

(22) Filed: Mar. 29, 2007

(30) Foreign Application Priority Data
Mar. 30, 2006 (JP) 093391/2006

(51) Int. Cl. G06K 9/46

(52) U.S. Cl. 382/195

(57) ABSTRACT

Detection of sightlines of faces within images is performed efficiently. A facial image is detected from within an entire image. A plurality of eye characteristic points and facial characteristic points are extracted from the detected facial image. Thereafter, eye features and facial features are generated, based on the extracted eye characteristic points and facial characteristic points. A characteristic vector that has the eye features and facial features as vector components is generated. A sightline is detected employing the generated characteristic vector.

### BACKGROUND OF THE INVENTION

1. Field of the Invention

The present invention relates to a method, an apparatus, and a program for detecting sightlines of people who are pictured within images.

2. Description of the Related Art

Various applications that employ human sightlines have been proposed, such as controlling automobiles by detecting the sightlines of drivers, and selecting photographed images to be kept and discarded by detecting the sightlines of subjects therein. Methods for detecting human sightlines are being investigated, in order to realize these applications. An example of such a method is to image human eyes to detect the positions of pupils using infrared irradiating devices or cameras fixed to human heads, thereby specifying sightlines.

Methods for detecting sightlines of human subjects by image processing, without employing devices for detecting the sightlines, have also been proposed. An example of a method that employs image processing detects the positions of irises or the centers of pupils to detect sightlines (refer to, for example, T. Ishikawa et al., “Passive Driver Gaze Tracking with Active Appearance Models”, Proceedings of the 11th World Congress on Intelligent Transportation Systems, October, 2004).

In the aforementioned method disclosed by Ishikawa et al., calculation of facing directions and gazing directions become necessary, in the case that detection of facing directions and gazing directions are performed separately. This increases the amount of calculations, and causes a problem that sightline detection takes a great amount of time.

### SUMMARY OF THE INVENTION

The present invention has been developed in view of the foregoing circumstances, and it is an object of the present invention to provide a method, apparatus, and program for detecting sightlines which is capable of detecting sightlines efficiently.

A sightline detecting method of the present invention comprises the steps of:

detecting a facial image from within an entire image;

extracting a plurality of eye characteristic points from within eyes of the detected facial image;

extracting a plurality of facial characteristic points from facial parts that constitute a face within the facial image;

generating eye features that indicate the gazing direction of the eyes, employing the plurality of extracted eye characteristic points;

generating facial features that indicate the facing direction of the face, employing the plurality of extracted facial characteristic points; and

detecting a sightline, employing the generated eye features and the generated facial features.

A sightline detecting apparatus of the present invention comprises:

detecting means, for detecting a facial image from within an entire image;

characteristic point extracting means, for extracting a plurality of eye characteristic points from within eyes of the detected facial image, and for extracting a plurality of facial characteristic points from facial parts that constitute a face within the facial image;

feature generating means, for generating eye features that indicate the gazing direction of the eyes, employing the plurality of extracted eye characteristic points, and for generating facial features that indicate the facing direction of the face, employing the plurality of extracted facial characteristic points; and

sightline detecting means, for detecting a sightline, employing the generated eye features and the generated facial features.

A sightline detecting program of the present invention causes a computer to execute a sightline detecting method, comprising the procedures of:

detecting a facial image from within an entire image;

extracting a plurality of eye characteristic points from within eyes of the detected facial image;

extracting a plurality of facial characteristic points from facial parts that constitute a face within the facial image;

generating eye features that indicate the gazing direction of the eyes, employing the plurality of extracted eye characteristic points;

generating facial features that indicate the facing direction of the face, employing the plurality of extracted facial characteristic points; and

detecting a sightline, employing the generated eye features and the generated facial features.

Here, “facial parts that constitute a face” refer to structural elements of a face, such as eyes, nose, lips, ears, and an outline of the face. The facial characteristic points may be extracted from a single facial part or a plurality of facial parts. For example, the facial characteristic points may be extracted from the nose and the lips. The eye characteristic points may be any points extracted from the eyes within the facial image. For example, the eye characteristic points may be extracted from the edges of pupils, or from along the outer peripheries of the eyes.

The characteristic point extracting means may employ any method to detect the characteristic points. For example, a pattern matching algorithm, an AdaBoosting algorithm, or an SVM (Support Vector Machine) algorithm may be employed to detect the characteristic points.

Note that the feature generating means may calculate the facial features and eye features in any manner as long as the facial features and eye features are calculated employing the characteristic points. For example, the feature generating means may calculate the distances between each of the eye characteristic points and generate the ratios of the calculated distances as the eye features. Further, the feature generating means may calculate the distances between each of the facial characteristic points, and generate the ratios of the calculated distances as the facial features.

The sightline detecting means may detect the sightline in any manner as long as both the facial features and the eye features are employed. For example, characteristic vectors having the eye features and the facial features as vector components may be generated, then employed to perform pattern classification. The pattern classification may be performed by the SVM algorithm or by a neural network technique. At this time, the sightline detecting means may be that which has performed machine learning to classify the characteristic vectors into a class of forward facing sightlines and a class of sightlines facing other directions, in order to detect sightlines.

The face detecting means may detect facial images by any method, and may comprise, for example:

partial image generating means, for generating a plurality of partial images by scanning a subwindow, which is a frame surrounding a set number of pixels; and

face classifiers, for performing final discrimination regarding whether the plurality of partial images represent faces, employing discrimination results of a plurality of weak classifiers.

Note that the face detecting means may detect only forward facing faces from the entire image. Alternatively, the face detecting means may function to detect forward facing faces, faces in profile, and inclined faces. In this case, a plurality of the sightline detecting means may be provided, corresponding to the forward facing faces, the faces in profile, and the inclined faces detected by the face detecting means.

The sightline detecting method, the sightline detecting apparatus, and the sightline detecting program of the present invention detect a facial image from within an entire image; extract a plurality of eye characteristic points from within eyes of the detected facial image; extract a plurality of facial characteristic points from facial parts that constitute a face within the facial image; generate eye features that indicate the gazing direction of the eyes, employing the plurality of extracted eye characteristic points; generate facial features that indicate the facing direction of the face, employing the plurality of extracted facial characteristic points; and detect a sightline, employing the generated eye features and the facial features. Accordingly, the sightline can be detected without detecting the facing direction and the gazing direction separately, and therefore, sightline detection can be performed efficiently.

Note that the sightline detecting means may generate characteristic vectors having the eye features and the facial features as vector components, then employ the generated characteristic vectors to perform pattern classification, to perform sightline detection. In this case, sightline detection can be performed efficiently.

Further, the sightline detecting means may be that which has performed machine learning to classify the characteristic vectors into a class of forward facing sightlines and a class of sightlines facing other directions. In this case, facial images having forwardly directed sightlines can be accurately classified by the patterns thereof.

The feature generating means may calculate the distances between each of the eye characteristic points and generate the ratios of the calculated distances as the eye features. Further, the feature generating means may calculate the distances between each of the facial characteristic points, and generate the ratios of the calculated distances as the facial features. In this case, fluctuations due to differences of the positions of eyes and other parts that constitute faces among individuals can be eliminated, and the general applicability of the method, apparatus, and program for detecting sightlines of the present invention can be improved.

The face detecting means may comprise: partial image generating means, for generating a plurality of partial images by scanning a subwindow, which is a frame surrounding a set number of pixels; and face classifiers, for performing final discrimination regarding whether the plurality of partial images represent faces, employing discrimination results of a plurality of weak classifiers. In this case, face detection can be performed accurately and efficiently.

The eye characteristic points may be extracted from the edges of pupils, or from along the outer peripheries of the eyes, and the facial characteristic points may be extracted from the nose and the lips. In this case, the gazing directions and the facing directions can be positively detected.

The face detecting means may comprise a plurality of face classifiers corresponding to forward facing faces, faces in profile, and inclined faces. A plurality of sightline detecting means may be provided, corresponding to the forward facing faces, the faces in profile, and the inclined faces detected by the face detecting means. In this case, sightline detection can be performed with respect to faces facing various directions.

Note that the program of the present invention may be provided being recorded on a computer readable medium. Those who are skilled in the art would know that computer readable media are not limited to any specific type of device, and include, but are not limited to: CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object, and executable code, and can be in any language, including higher level languages, assembly language, and machine language.

### BRIEF DESCRIPTION OF THE DRAWINGS

FIG. 1 is a block diagram that illustrates the configuration of a sightline detecting apparatus according to a first embodiment of the present invention.

FIG. 2 is a block diagram that illustrates an example of a face detecting means of the sightline detecting apparatus of FIG. 1.

FIGS. 3A, 3B, 3C, and 3D are diagrams that illustrate how a partial image generating means of FIG. 2 scans subwindows.

FIG. 4 is a diagram that illustrates how characteristic amounts are extracted from partial images, by each weak classifier of FIG. 2.

FIG. 5 is a graph that illustrates an example of a histogram of the weak classifier of FIG. 2.

FIG. 6 is a block diagram that illustrates an example of a characteristic point extracting means of FIG. 1.

FIG. 7 is a diagram that illustrates how template matching is performed by the characteristic point extracting means of FIG. 6.

FIGS. 8A, 8B, and 8C are diagrams that illustrate how characteristic points are extracted from template images by the characteristic point extracting means of FIG. 6.

FIG. 9 is a diagram that illustrates an example of a facial image, in which characteristic points have been detected by the characteristic point extracting means of FIG. 6.

FIG. 10 is a flow chart that illustrates a preferred embodiment of the sightline detecting method of the present invention.

FIG. 11 is a block diagram that illustrates a sightline detecting apparatus according to a second embodiment of the present invention.

FIGS. 12A, 12B, and 12C are diagrams that illustrate the differences in the positions of characteristic points in forward facing faces, faces in profile, and inclined faces, in which sightlines are directed forward.

### DESCRIPTION OF THE PREFERRED EMBODIMENTS

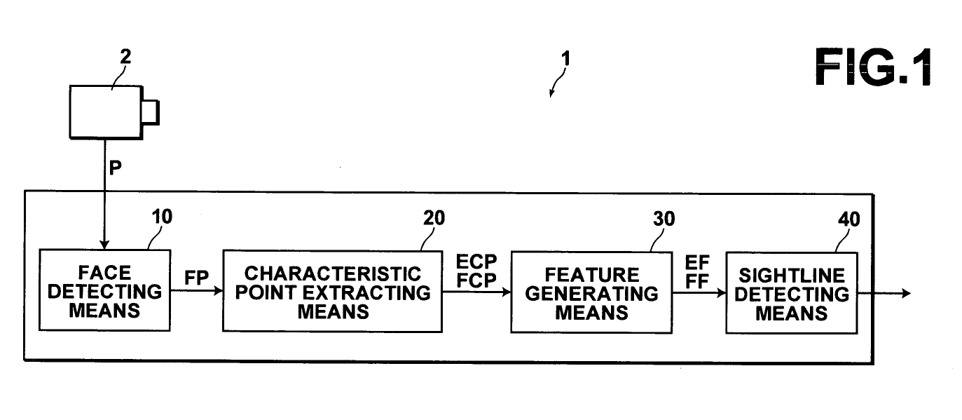

Hereinafter, embodiments of the sightline detecting apparatus of the present invention will be described in detail with reference to the attached drawings. FIG. 1 is a block diagram that illustrates the configuration of a sightline detecting apparatus 1 according to a first embodiment of the present invention. Note that the configuration of the sightline detecting apparatus 1 is realized by executing a sightline detecting program, which is read into an auxiliary memory device, on a computer (a personal computer, for example). The sightline detecting program is recorded in a data medium such as a CD-ROM, or distributed via a network such as the Internet, and installed in the computer.

The sightline detecting apparatus 1 detects sightlines of forward facing faces, and comprises: a face detecting means, for detecting facial images FP from entire images P; a characteristic point extracting means 20, for extracting a plurality of eye characteristic points ECP and a plurality of facial characteristic points FCP from the facial images FP; a feature generating means 30, for generating eye features EF that indicate gazing directions of eyes from the eye characteristic points ECP, and for generating facial features FF that indicate facing directions of faces from the facial characteristic points FCP; and a sightline detecting means 40, for detecting sightlines by employing the generated eye features EF and the generated facial features FF.

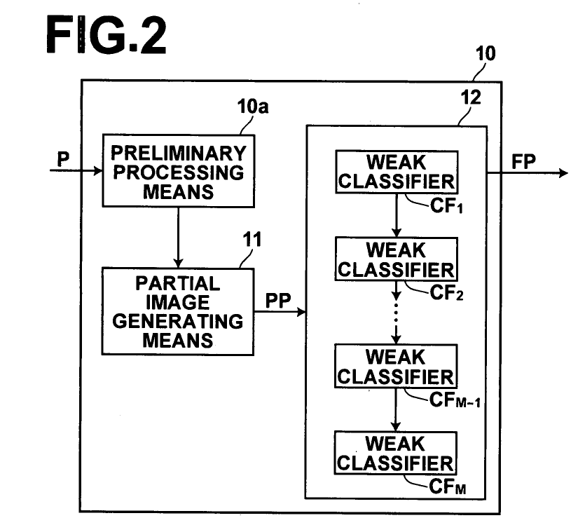

The face detecting means 10 discriminates faces from within entire images P, which have been obtained by a digital camera 2, for example, and functions to extract the discriminated faces as facial images FP. As illustrated in FIG. 2, the face detecting means 10 comprises: a partial image generating means 11, for generating partial images PP by scanning a subwindow W on the entire images P; and a face classifier 12, for detecting partial images that represent faces from among the plurality of partial images PP generated by the partial image generating means 11.

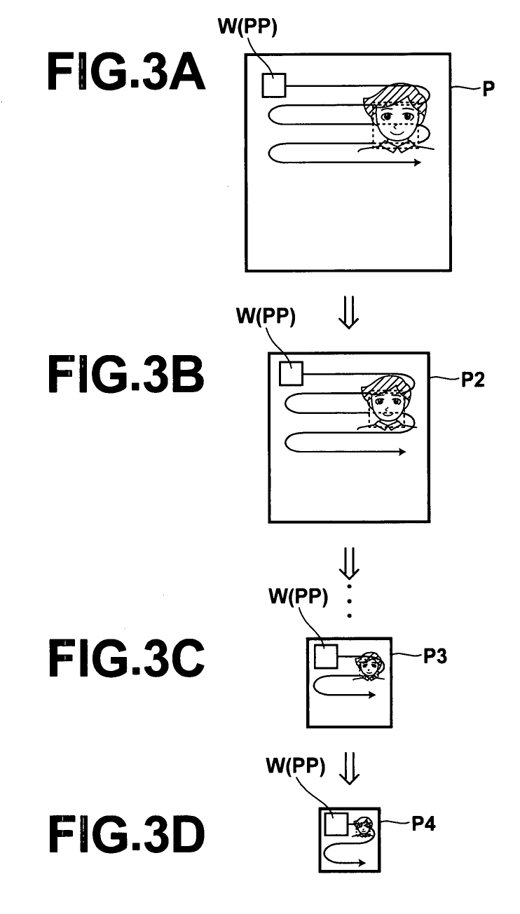

Note that preliminary processes are administered on the entire images P by a preliminary processing means 10a, prior to the entire images P being input to the partial image generating means 11. The preliminary processing means 10a generates a plurality of entire images P2, P3, and P4 having different resolutions from the entire images P, as illustrated in FIGS. 3A through 3D. Further, the preliminary processing means 10a administers a normalizing process (hereinafter, referred to as a “local normalizing process”) that suppresses fluctuations in contrast within local regions of the plurality of entire images P, P2, P3, and P4, across the entireties of the entire images P, P2, P3, and P4. As illustrated in FIG. 3A, the partial image generating means 11 scans the subwindow W having a set number of pixels (32 pixels by 32 pixels, for example) within the entire images P, and cuts out regions surrounded by the subwindow W to generate the partial images PP having a set number of pixels.

Note that the partial image generating means 11 also generates partial images PP by scanning the subwindow W within the generated lower resolution images as well, as illustrated in FIGS. 3B through 3D. Thereby, even in the case that faces (discrimination target) pictured in the entire images P do not fit within the subwindow W, it becomes possible to fit the faces within the subwindow W in the lower resolution images. Accordingly, faces can be positively detected.

The face classifier 12 of FIG. 2 functions to perform binary discrimination regarding whether the partial images PP represent faces. The face classifier 12 is that which has performed learning by the AdaBoosting algorithm, and comprises a plurality of weak classifiers CF₁ through CF_{M} (M is the number of weak classifiers). Each of the weak classifiers CF₁ through CF_{M} extracts features x from the partial images PP, and discriminates whether the partial images PP represent faces employing the features x. The face classifier 12 performs final judgment regarding whether the partial images PP represent faces, employing the discrimination results of the weak classifiers CF₁ through CF_{M}.

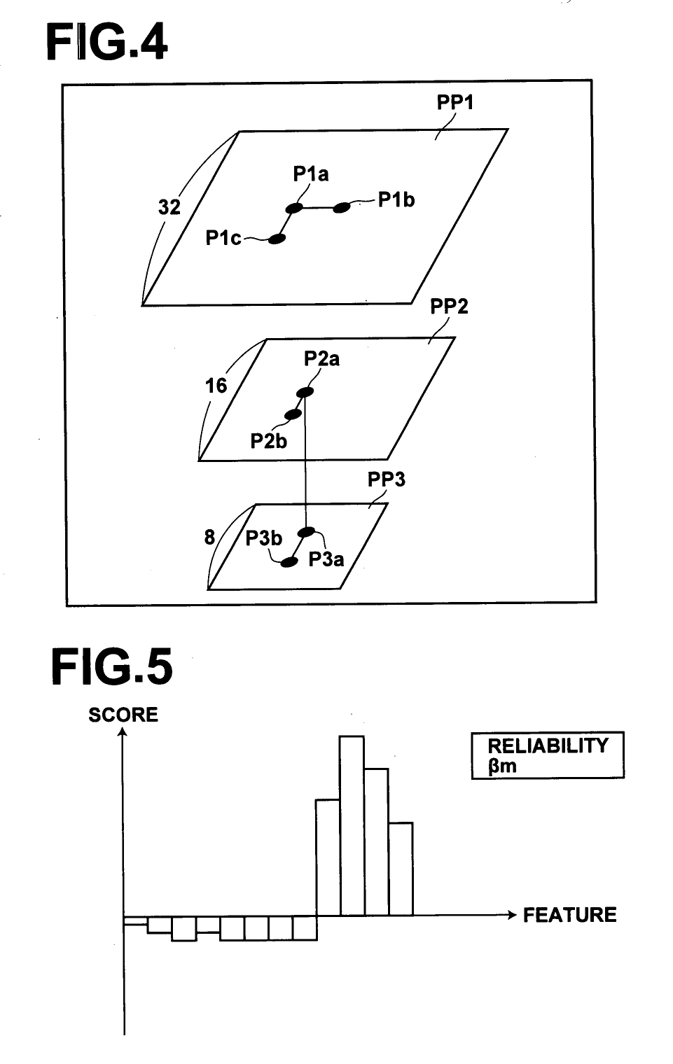

Specifically, each of the weak classifiers CF₁ through CF_{M} extracts brightness values or the like of coordinate positions P1a, P1b, and P1c within the partial images PP, as illustrated in FIG. 4. Further, green signal values or red signal values of coordinate positions P2a, P2b, P3a, and P3b are extracted from lower resolution images PP2 and PP3 of the partial images PP, respectively. Thereafter, the seven coordinate positions P1a through P3b are combined as pairs, and the differences in brightness values of each of the pairs are designated to be the features x. Each of the weak classifiers CF₁ through CF_{M} employs different features. For example, the weak classifier CF₁ employs the difference in brightness values between coordinate positions P1a and P1c as the feature x, while the weak classifier CF₂ employs the difference in brightness values between coordinate positions P2a and P2b as the feature x.

Note that a case has been described in which each of the weak classifiers CF₁ through CF_{M} extracts features x. Alternatively, the features x may be extracted in advance for a plurality of partial images PP, then input into each of the weak classifiers CF₁ through CF_{M}. Further, a case has been described in which brightness values are employed to calculate the features x. Alternatively, data, such as that which represents contrast or edges, may be employed to calculate the features x.

Each of the weak classifiers CF₁ through CF_{M} has a histogram such as that illustrated in FIG. 5. The weak classifiers CF₁ through CF_{M} output scores f1(x) through f_{M}(x) according to the values of the features x based on these histograms. Further, the weak classifiers CF₁ through CF_{M} have confidence values βₐ through β_{M} that represent the levels of discrimination performance thereof. The weak classifiers CF₁ through CF_{M} calculate discrimination scores β_{M·f}_{M}(x) by multiplying the scores f₁(x) through f_{M}(x) by the confidence values β₁ through β_{M}. Whether the discrimination score β_{M}·f_{M}(x) of each weak classifier CFₘ is greater than or equal to a threshold value Sref is judged. A partial image PP is judged to represent a face when the discrimination score β_{M}·f_{M}(x) is equal to or greater than the threshold value Sref(β_{M}·f_{M}(x)≧Sref) .

The weak classifiers CF₁ through CF_{M} of the face classifier 12 are configured in a cascade structure. Only partial images PP which have been judged to represent faces by all of the weak classifiers CF₁ through CF_{M} are output as candidate images CP. That is, discrimination is performed by a downstream weak classifier CFₘ₊₁ only on partial images in which faces have been discriminated by the weak classifier CFₘ. Partial images PP in which faces have not been discriminated by the weak classifier CFₘ are not subjected to discrimination operations by the downstream weak classifier CFₘ₊₁. The number of partial images PP to be discriminated by the downstream weak classifiers can be reduced by this structure, and accordingly, the discrimination operations can be accelerated. Note that the details of classifiers having cascade structures are disclosed in S. Lao et al., “Fast Omni-Directional Face Detection”, MIRU 2004, pp. II271-II276, July, 2004.

Note that in the case described above, each of the discrimination scores β_{M}·f_{M}(x) are individually compared against the threshold value Sref to judge whether a partial image PP represents a face. Alternatively, discrimination may be performed by comparing the sum Σᵣ₌₁^{m}βᵣ·fᵣ(x) of the discrimination scores of upstream weak classifiers CF₁ through CFₘ₋₁ against a predetermined threshold value S1ref(Σᵣ₌₁^{m}βᵣ·fᵣ(x)≧S1ref). The discrimination accuracy can be improved by this method, because judgment can be performed while taking the discrimination scores of upstream weak classifiers into consideration.

A case has been described in which the face detecting means 10 detects faces employing the AdaBoosting algorithm. Alternatively, faces maybe detected employing the known SVM (Support Vector Machine) algorithm.

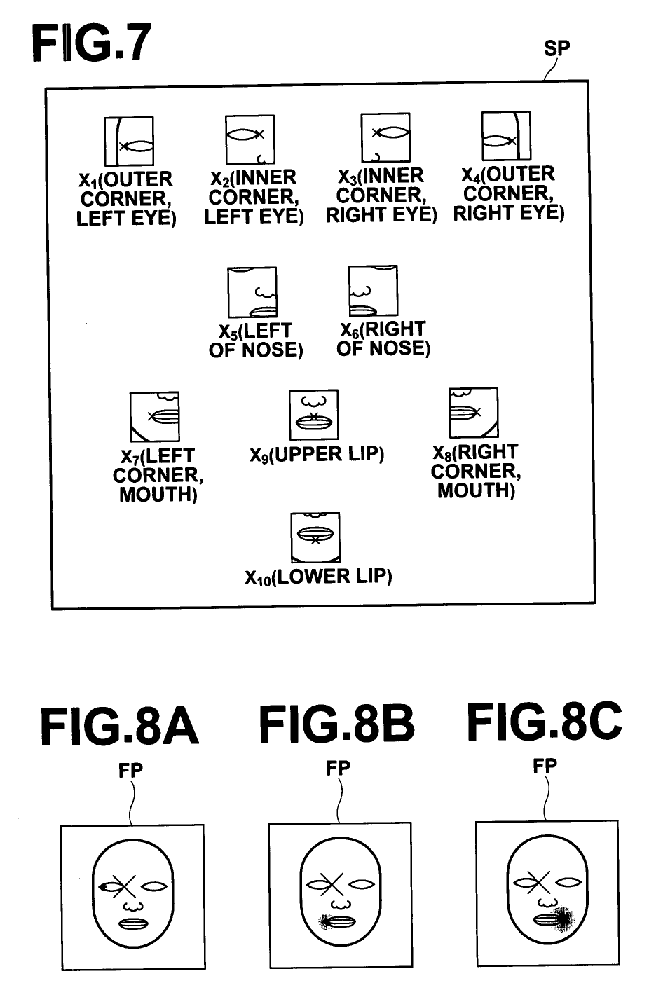

The characteristic point extracting means 20 of FIG. 1 extracts eye characteristic points ECP and facial characteristic points FCP from the facial images FP detected by the face detecting means 10. The characteristic points are extracted by methods such as those described in Japanese Unexamined Patent Publication No. 6(1994)-348851, Japanese Patent Application No. 2006-045493, and by D. Cristinacce et al., “A Multi-Stage Approach to Facial Feature Detection”, Proceedings of BMVC, pp. 231-240, 2004. Specifically, the characteristic point extracting means 20 comprises: a characteristic point candidate classifier 21, for detecting candidate characteristic points from within the facial images FP; a probability calculating means 22, for calculating the probabilities that the candidate characteristic points detected by the characteristic point candidate classifier 21 are characteristic points; and a characteristic point estimating means 23, for estimating the positions of the characteristic points by employing the probabilities calculated by the probability calculating means 22. The characteristic point candidate classifier 21 is that which has performed learning by the AdaBoosting algorithm using sample images SP, which have characteristic points at the substantial centers thereof, as illustrated in FIG. 7. Candidate characteristic points Xi are detected by a method similar to that employed in the face detection described above. Specifically, partial facial images are generated from the facial images FP, features are extracted from the partial facial images, and the features are employed to judge whether the partial facial images have characteristic points at the substantial centers thereof. The characteristic point candidate classifier 21 detects the candidate characteristic points Xi from facial images FP, in which partial images which have been judged to have characteristic points at the centers thereof are present.

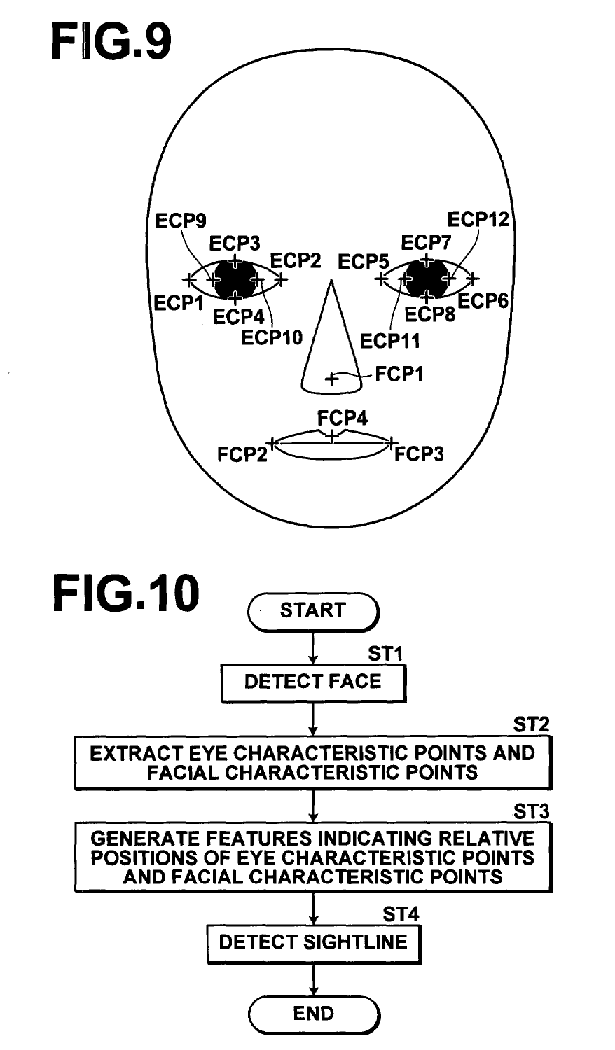

The probability calculating means 22 employs position probability distributions, which are stored in a database 22a, to calculate the probability that each candidate characteristic point Xi is actually a characteristic point. Specifically, a position probability distributions of: the outer corner of the right eye using the inner corner of the right eye as a reference, as illustrated in FIG. 8A; the right corner of the mouth using the inner corner of the right eye as a reference, as illustrated in FIG. 8B; the left corner of the mouth using the inner corner of the right eye as a reference; and the like are stored in the database 22a. The probability calculating means 22 calculates the sum (or the product) of the positional probability for each candidate characteristic point Xi, estimated from all of the other candidate characteristic points Xi. The characteristic point estimating means 23 extracts candidate characteristic points Xi having high positional probabilities as the characteristic points, based on the calculated sums (or products) of the positional probabilities. Then, a plurality of eye characteristic points ECP1 through ECP12, and a plurality of facial characteristic points FCP1 through FCP4 are extracted from portions of the facial images FP that constitute eyes and faces, as illustrated in FIG. 9.

The feature generating means 30 generates eye features EF by employing the eye characteristic points ECP1 through ECP12, and generates facial features FF by employing the facial characteristic points FCP1 through FCP4. Here, the feature generating means 30 generates the ratios of distances between each of the characteristic points as the features. Specifically, the feature generating means 30 extracts the ratios: distance from the outer corner of the eye ECP1 to the pupil ECP9/distance from outer corner of the eye ECP1 to the inner corner of the eye ECP2; and distance from the inner corner of the eye ECP2 to the pupil ECP10/distance from the outer corner of the eye ECP1 to the inner corner of the eye ECP2; as an eye feature EF that indicates the horizontal gazing direction of the right eye. In addition, the feature generating means 30 extracts the ratios: distance from the outer corner of the eye ECP6 to the pupil ECP12/distance from outer corner of the eye ECP6 to the inner corner of the eye ECP5; and distance from the inner corner of the eye ECP5 to the pupil ECP11/distance from the outer corner of the eye ECP6 to the inner corner of the eye ECP5; as an eye feature EF that indicates the horizontal gazing direction of the left eye. Further, the feature generating means 30 extracts the ratios: distance from the upper eyelid ECP3 to the lower eyelid ECP4/distance from the outer corner of the eye ECP1 to the inner corner of the eye ECP2; and distance from the upper eyelid ECP7 to the lower eyelid ECP8/distance from the outer corner of the eye ECP6 to the inner corner of the eye ECP5; as eye features EF that indicate the vertical gazing directions of the right and left eyes.

At the same time, the feature generating means 30 extracts the ratios: distance from the midpoint between the outer corner of the right eye ECP1 and the inner corner of the right eye ECP2 to the nose FCP1/ distance from the midpoint between the outer corner of the left eye ECP6 and the inner corner of the left eye ECP5 to the nose FCP1; and distance from the right corner of the mouth FCP2 to the center of the lips FCP4/ distance from the left corner of the mouth FCP3 to the center of the lips FCP4; as facial features FF. As described above, the feature generating means 30 generates six eye features EF and two facial features FF. By employing the ratios of the calculated distances as the facial features, fluctuations due to differences of the positions of the characteristic points among individual human subjects and the resulting deterioration of detection accuracy can be prevented.

The sightline detecting means 40 employs the SVM (Support Vector Machine) algorithm to detect sightlines by classification into a class of forward facing sightlines (toward the digital camera 2) and a class of sightlines facing other directions. Specifically, the sightline detecting means 40 generate characteristic vectors CV, having the plurality of eye features EF and the plurality of facial features FF as vector components, then calculates binary output values with respect to the characteristic vectors CV. For example, the sightline detecting means 40 outputs whether sightlines face forward or other directions, by inputting the characteristic vectors CV into a linear discriminating function:

y(x)=sign(ω^{T}x−h)

wherein ω^{T} is a parameter that corresponds to synapse weighting, and h is a predetermined threshold value. If y(x)=1, then the sightlines are judged to be facing forward, and if y(x)=−1, then the sightlines are facing other directions. The parameter ω^{T} and the threshold value h are determined by the sightline detecting means 40, based on machine learning using sample images of eyes in which sightlines face forward. The sightline detecting means 40 may detect sightlines by other known pattern classifying techniques, such as a neural network technique, instead of the SVM algorithm described above.

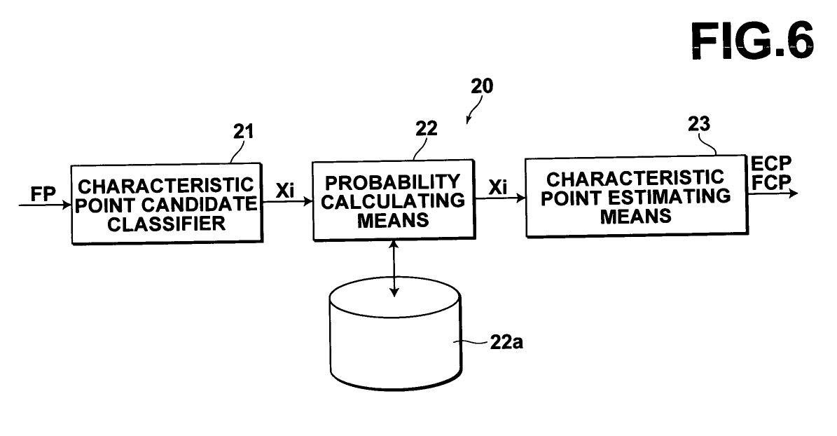

FIG. 10 is a flow chart that illustrates a preferred embodiment of the sightline detecting method of the present invention. The steps of the face detecting method will be described with reference to FIGS. 1 through 10. First, the face detecting means 10 detects a facial image FP from within an entire image P (step ST1, refer to FIGS. 1 through 5). Next, the characteristic point extracting means 20 extracts a plurality of eye characteristic points ECP and facial characteristic points FP from the detected facial image FP (step ST2, refer to FIGS. 6 through 9). Thereafter, the feature generating means 30 generates eye features EF and facial features FF from the extracted characteristic points ECP and FP (step ST3). Then, the sightline detecting means 40 generates a characteristic vector CV which has the eye features EF and the facial features FF as vector components, and sightline detection is performed (step ST4).

The sightline is detected based on the relationship among the eye features EF and the facial features FF. Thereby, efficient sightline detection becomes possible. That is, conventional methods discriminate both facing directions and gazing directions, and detect the sightlines of human subjects based on the relationship between the two directions. Therefore, a detecting process to detect the gazing direction and a detecting process to detect the facing direction are both necessary. On the other hand, the sightline detecting method executed by the sightline detecting apparatus 1, focuses on the fact that sightlines can be detected without independently detecting gazing directions and facing directions, if the relative relationship between the gazing direction and the facing direction can be discriminated. That is, the sightline detecting apparatus detects sightlines based on the relative relationship among the eye features EF and the facial features FF, without discriminating the gazing direction and the facing direction. Accordingly, the amount of calculations and time required therefor to detect sightlines can be reduced, and efficient sightline detection can be performed.

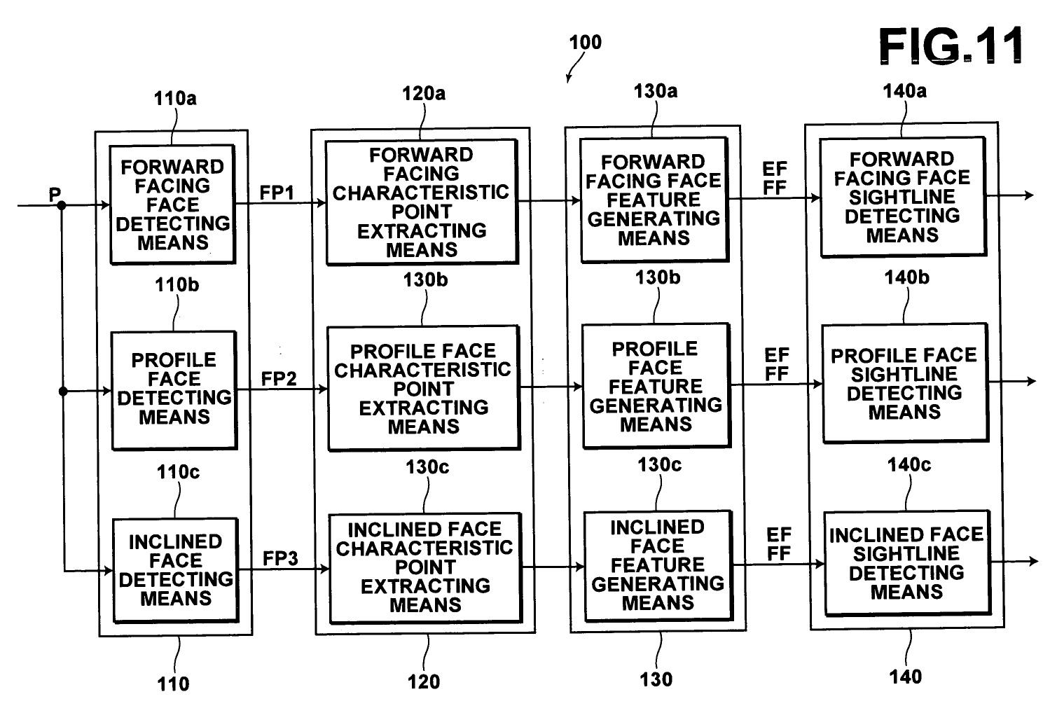

FIG. 11 is a block diagram that illustrates a sightline detecting apparatus 100 according to a second embodiment of the present invention. Note that components of the sightline detecting apparatus 100 which are the same as those of the sightline detecting apparatus 1 of FIG. 1 are denoted with the same reference numerals, and detailed descriptions thereof will be omitted insofar as they are not particularly necessary. The sightline detecting apparatus 100 of FIG. 11 differs from the sightline detecting apparatus 1 of FIG. 1 in that face detecting means, characteristic point extracting means, feature generating means, and sightline detecting means are provided corresponding to forward facing faces, faces in profile, and inclined faces, respectively.

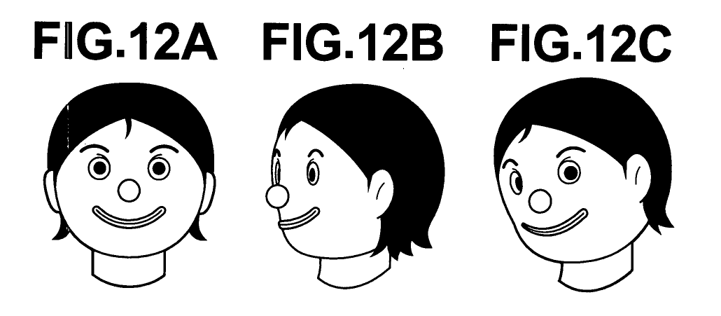

Each of the face detecting means 110a through 110c detect faces by methods similar to that employed by the face detecting means 10 (refer to FIG. 1). However, each of the face detecting means 110a through 110c comprise face classifiers which have performed learning corresponding to the facing direction of faces to be detected. Forward facing faces FP1, faces in profile FP2, and inclined faces FP3 are detected by the face detecting means 110a through 110c, respectively. Each of the characteristic point extracting means 120a through 120c take into account that the shapes (appearances) of constituent components of faces differ within forward facing faces FP1 (refer to FIG. 12A), faces in profile FP2 (refer to FIG. 12B), and inclined faces FP3 (refer to FIG. 12C). Different template images TP are used for each facing direction, and characteristic points are extracted from positions within the facial images FP1 through FP3 which are suited for sightline detection.

Each of the feature generating means 130a through 130c generate eye features EF and facial features FF employing the extracted characteristic points by methods similar to that employed by the feature generating means 30 (refer to FIG. 1). Each of the sightline detecting means 140a through 140c generate characteristic vectors CV having the plurality of eye features EF and the plurality of facial features FF as vector components, and detect sightlines employing the characteristic vectors CV by methods similar to that employed by the sightline detecting means 40. Note that each of the sightline detecting means 140a through 140c have performed learning employing eye features EF and facial features FF when sightlines are facing forward for each facing direction as sample data.

In this manner, face detection, characteristic point extraction, feature generation, and sightline detection are performed for each of forward facing faces FP1, faces in profile FP2, and inclined faces FP3. Thereby, sightline detection corresponding to each facing direction can be performed. Accordingly, sightline detection can be accurately and efficiently performed in cases that facing directions are different. For example, the positional relationships among the inner corners, the outer corners, and the pupils of eyes (eye characteristic points), as well as the positional relationships among eyes, noses, and lips (facial characteristic points) differ between forward facing faces and inclined faces, even if sightlines face forward in both cases. Specifically, the sightline is determined by the correlative relationship between the facing direction and the gazing direction. For example, in the case that facial images FP in which forwardly directed sightlines are to be detected, facial images FP in which both the facing direction and the gazing direction are directed forward are detected if faces are facing forward, such as that illustrated in FIG. 12A. However, in the case that faces are turned rightward, such as that illustrated in FIG. 12B, it is necessary to detect facial images FP in which the gazing direction is leftward (toward the digital camera 2) with respect to the facing direction. Therefore, by providing the face detecting means, the characteristic point extracting means, the feature generating means, and the sightline detecting means corresponding to each facing direction, sightline detection can be performed accurately and efficiently regardless of the facing direction.

The feature generating means 30 of FIG. 1 calculates the distances between each of the eye characteristic points ECP and generates the ratios of the calculated distances as the eye features EF. Further, the feature generating means 30 calculates the distances between each of the facial characteristic points FCP, and generates the ratios of the calculated distances as the facial features FF. Therefore, fluctuations due to differences of the positions of eyes and other parts that constitute faces among individuals are eliminated, and the general applicability of the method, apparatus, and program for detecting sightlines of the present invention is improved.

The face detecting means 10 of FIG. 2 comprises: the partial image generating means 11, for generating the plurality of partial images PP by scanning the subwindow W, which is a frame surrounding a set number of pixels; and the face classifier 12, for performing final discrimination regarding whether the plurality of partial images PP represent faces, employing discrimination results of a plurality of weak classifiers. Therefore, face detection can be performed accurately and efficiently.

The eye characteristic points ECP are extracted from the edges of pupils, and from along the outer peripheries of the eyes, and the facial characteristic points FCP are extracted from the nose and the lips. Therefore, the gazing directions and the facing directions can be positively detected.

The sightline detecting means 40 has performed machine learning to discriminate sightlines which are directed forward and sightlines which are directed in other directions, and sightlines are detected by pattern classification employing characteristic vectors. Therefore, sightlines can be accurately detected.

The face detecting means 10 comprises the plurality of face classifiers corresponding to forward facing faces, faces in profile, and inclined faces. A plurality of sightline detecting means are provided, corresponding to the forward facing faces, the faces in profile, and the inclined faces detected by the face detecting means. Therefore, sightline detection can be performed with respect to faces facing various directions.

What is claimed is:

1. A sightline detecting method, comprising the steps of:
detecting a facial image from within an entire image;
extracting a plurality of eye characteristic points from within eyes of the detected facial image;
extracting a plurality of facial characteristic points from facial parts that constitute a face within the facial image;
generating eye features that indicate the gazing direction of the eyes, employing the plurality of extracted eye characteristic points;
generating facial features that indicate the facing direction of the face, employing the plurality of extracted facial characteristic points; and
detecting a sightline, employing the generated eye features and the generated facial features.

2. A sightline detecting apparatus, comprising:
detecting means, for detecting a facial image from within an entire image;
characteristic point extracting means, for extracting a plurality of eye characteristic points from within eyes of the detected facial image, and for extracting a plurality of facial characteristic points from facial parts that constitute a face within the facial image;
feature generating means, for generating eye features that indicate the gazing direction of the eyes, employing the plurality of extracted eye characteristic points, and for generating facial features that indicate the facing direction of the face, employing the plurality of extracted facial characteristic points; and
sightline detecting means, for detecting a sightline, employing the generated eye features and the generated facial features.

3. A sightline detecting apparatus as defined in claim 2, wherein the sightline detecting means detects the sightline by:
generating characteristic vectors having the eye features and the facial features as vector components; and
employing the characteristic vectors to perform pattern classification.

4. A sightline detecting apparatus as defined in claim 3, wherein:
the sightline detecting means has performed machine learning to classify the characteristic vectors into a class of forward facing sightlines and a class of sightlines facing other directions.

5. A sightline detecting apparatus as defined in claim 2, wherein the feature generating means:
calculates the distances between each of the eye characteristic points;
generates the ratios of the calculated distances as the eye features;
calculates the distances between each of the facial characteristic points; and
generates the ratios of the calculated distances as the facial features.

6. A sightline detecting apparatus as defined in claim 2, wherein:
the eye characteristic points are extracted from the pupils, the inner corners, and the outer corners of the eyes; and
the facial characteristic points are extracted from the nose and the lips of the face.

7. A sightline detecting apparatus as defined in claim 2, wherein the face detecting means comprises:
partial image generating means, for generating a plurality of partial images by scanning a subwindow, which is a frame surrounding a set number of pixels; and
face classifiers, for performing final discrimination regarding whether the plurality of partial images represent faces, employing discrimination results of a plurality of weak classifiers.

8. A sightline detecting apparatus as defined in claim 7, wherein:
the face detecting means comprises a plurality of face classifiers corresponding to forward facing faces, faces in profile, and inclined faces; and
a plurality of sightline detecting means are provided corresponding to the forward facing faces, faces in profile, and incline faces detected by the face detecting means.

9. A program that causes a computer to execute a sightline method, comprising the procedures of:
detecting a facial image from within an entire image;
extracting a plurality of eye characteristic points from within eyes of the detected facial image;
extracting a plurality of facial characteristic points from facial parts that constitute a face within the facial image;
generating eye features that indicate the gazing direction of the eyes, employing the plurality of extracted eye characteristic points;
generating facial features that indicate the facing direction of the face, employing the plurality of extracted facial characteristic points; and
detecting a sightline, employing the generated eye features and the generated facial features.

10. A computer readable program having the program of claim 9 recorded therein.
